(19) United States
(12) Patent Application Publication
(10) Pub. No.: US 2017/0344531 A1
(43) Pub. Date: Nov. 30, 2017

(54) PROVIDING AUTOMATIC CASE SUGGESTION

(71) Applicant: MICROSOFT TECHNOLOGY LICENSING, LLC, Redmond, WA (US)

(72) Inventor: Blair Neumann, Seattle, WA (US)

(73) Assignee: MICROSOFT TECHNOLOGY LICENSING, LLC, Redmond, WA (US)

(21) Appl. No.: 15/163,693

(22) Filed: May 25, 2016

(51) Int. Cl. G06F 17/27; G06F 17/24; G06F 3/0489; G06N 99/00; G06F 3/0482

(52) U.S. Cl. CPC G06F 17/274; G06N 99/005; G06F 3/0482; G06F 3/04895; G06F 17/24

(57) ABSTRACT

Techniques may be provided for automatic case suggestion. In some examples, a text processing engine may detect an initial typing of a word on a textual user interface, detect a case of a first character of the word as uppercase, and determine a first suggestion. The first suggestion may include remaining characters of the word being lowercase. The first suggestion may be provided to an application or a display engine to be displayed. The text processing engine may also detect a case of a second character of the word as uppercase and determine a second suggestion. The second suggestion includes all characters of the word being uppercase. The second suggestion may be provided to the application or the display engine to be displayed.

### BACKGROUND

Computing, devices, such as desktop computers laptop computers, and mobile devices, may include applications for composing and sending messages to other computing devices. Many of these messaging applications may allow users to quickly compose and send a message to another computing device. To prevent typographical errors, some messaging applications may include an autocorrect feature that may use one or more algorithms to identify misspelled words and identify common typographical errors. In response, the autocorrect feature may replace the misspelled words and the typographical errors with intended words or symbols. However, the autocorrect feature may erroneously correct words or phrases, without confirmation from a user, changing the meaning of the words or the phrases.

Further, in some examples, a user may wish to re-case a word (e.g., edit the case of one or more characters of the word from uppercase to lowercase or vice-versa); the autocorrect feature cannot perform this modification. Instead, the user may manually perform this process by selecting the one or more characters of the word and typing over the one more characters of the word to edit the case. The manual re-casing of the word is inefficient and time-consuming.

### SUMMARY

This is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing automatic case suggestion. In some examples, a text processing engine may detect an initial typing of a word, on a textual user interface, detect a case a first character of the word as uppercase, and determine a first suggestion. The first suggestion may include remaining characters of the word being lowercase. The first suggestion may be provided to an application or a display engine to be displayed. The text processing engine may also detect a case of a second character of the word as uppercase and determine a second suggestion. The second suggestion includes all characters of the word being uppercase. The second suggestion may be provided to the application or the display engine to be displayed.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1A is a conceptual diagram illustrating an example computing environment for re-casing words in response to receiving suggestion data from a data service, according to embodiments;

FIG. 1B is a conceptual diagram illustrating an example computing environment for re-casing words in response to receiving suggestion data from an app store, according to embodiments;

FIG. 2 is a display diagram illustrating a method to re-case words through providing suggestions in a suggestion pane on a textual user interface and prompting user action on the suggestion pane, according to embodiments;

FIG. 3 is a display diagram illustrating a method to re-case words in a sentence based on inferred intent associated with user actions executed on the words, according to embodiments;

FIG. 4 is a display diagram illustrating a method to modify an Arabic numeral value with alphabetic characters associated with the Arabic numeral value through providing suggestions in a suggestion pane on a textual user interface and prompting user action on the suggestion pane, according to embodiments;

FIG. 5 is a simplified networked environment, where a system according to embodiments may be implemented;

FIG. 6 is a block diagram of an example computing device, which may be used for providing automatic case suggestion, according to embodiments; and

FIG. 7 is a logic flow diagram illustrating a process for providing automatic case suggestion, according to embodiments.

### DETAILED DESCRIPTION

As briefly described above, embodiments are directed to providing automatic case suggestion. An initial typing of a word on a textual user interface may be detected. A case of a first character of the word may be detected. The case of the first character of the word may be uppercase. A first suggestion may be determined and may include remaining characters of the word being lowercase. The first suggestion may be provided to an application or a display engine to be displayed. A case of a second character of the word may be detected. The case of the second character of the word may be uppercase. A second suggestion may be determined. The second suggestion may include all characters of the word being uppercase. The second suggestion may be provided to the application or the display engine to be displayed.

In the following detailed description, references are made to the accompanying drawings that form a part hereof, and in which are shown by way of illustrations, specific embodiments, or examples. These aspects may be combined, other aspects may be utilized, and structural changes maybe made without departing from the spirit or scope of the present disclosure. The following detailed description is therefore not to be taken in a limiting sense, and the scope, of the present invention is defined by the appended claims and their equivalents.

While some embodiments will be described in the general context of program modules that execute in conjunction with art application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing, environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example, be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing automatic case suggestion. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and one or more processors that includes a server, a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs inconjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and, comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that allow the application or service to interact or communicate with one or more other applications and services managed by separate entities.

While example implementations are described using suggestions and suggestion data herein, embodiments are not limited to suggestions. Providing automatic case suggestion may be implemented in other environments, such as communications, instant messages, data sharing, application sharing, online conferencing, and similar communications, where suggestion data may be exchanged.

The technical advantages of providing automatic case suggestion;may include, among others, an increased efficiency in user interaction with the computing device. By inferring the user intent of the user actions executed on the words, suggestions may be generated, eliminating the manual re-casing of the words. Processing and network bandwidth may be reduced because the text processing engine may automatically determine the suggestions based on the case of each character of the word. Further, by decreasing a number of actions performed on the computing device to re-case the words, memory and processor burden may also be reduced.

Embodiments address a need that arises from very large scale of operations created by networked computing and cloud based services that cannot be managed by humans. The actions operations described herein are not a mere use of a computer, but address results of a system that is a direct consequence of software used as a service such as data services offered in conjunction with providing automatic case suggestion.

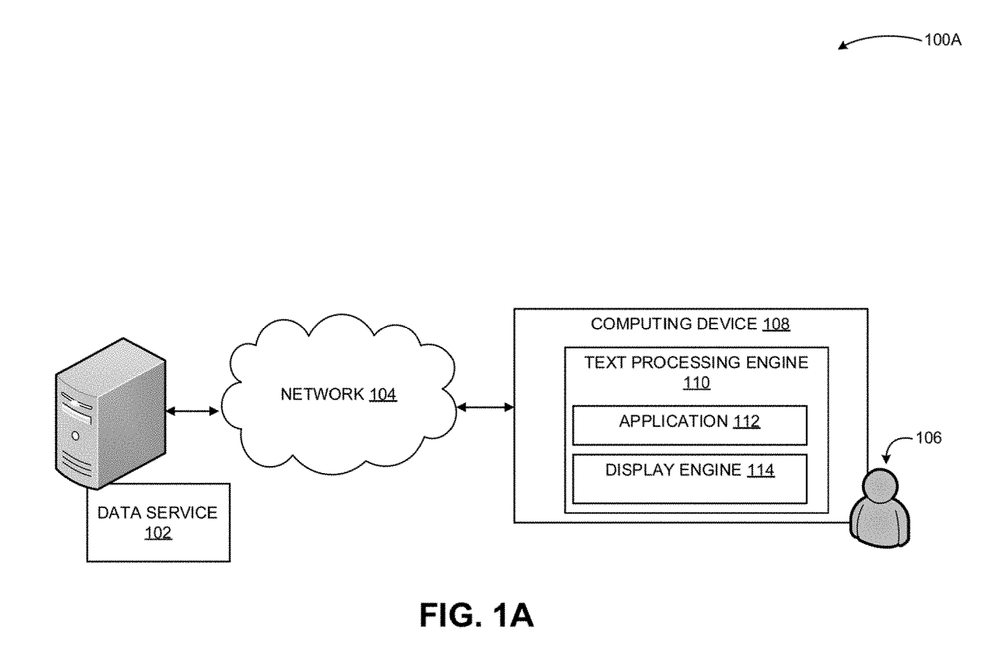

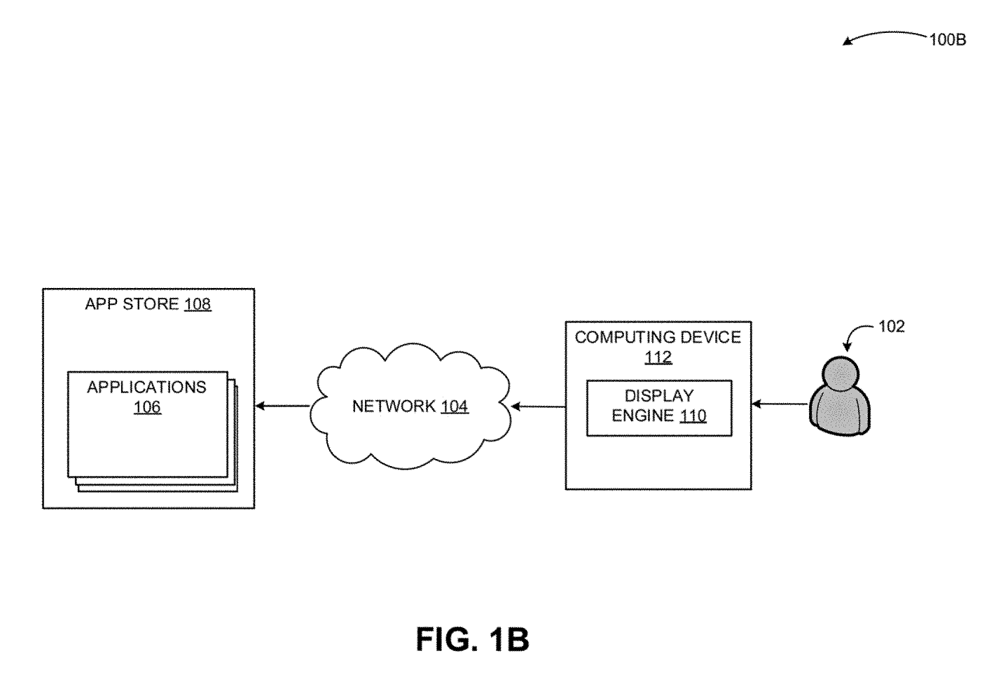

FIG. 1A is a conceptual diagram illustrating an example computing environment for re-casing words in response to receiving suggestion data from a data service, according to embodiments.

As shown in a diagram 100A, a computing device 108 may execute a text processing engine 110. The computing device 108 may include a display device, such as a touch enabled display component, and a monitor, among others, to provide the text processing engine 110 to a user 106. The computing device 108 may include a desktop computer, a laptop computer, a tablet, a handheld device, a vehicle mount computer, an embedded computer system, a smart phone, and/or a wearable computer, among other similar computing devices, for example.

In some examples, the text processing engine 110 may be provided by a third party service (e.g., a data service 102), web applications, and/or a datacenter, among others. Local access to the text processing engine 110 maybe provided by locally installed rich clients (e.g., a local version of the textprocessing engine 110) or generic applications, such as a browser on the computing device 108.

In further examples, the text processing engine 110 may be integrated into a system (e.g., a spellcheck system) of the computing device 108. In further examples, the text processing engine 110 may be a feature of an application executed on the computing device 108 (e.g., similar to an autocorrect feature of a document processing application executed on the computing device 108). In other examples, the text processing engine 110 may be a stand-alone module executed on an operation system of the computing device 108.

In other examples, the text processing engine 110 may be executed on a server (e.g., a data server). The server may include a web server or a document server, among others. The computing device 108 (e.g., a local system) may communicate with the server (e.g., a remote system) through network 104. The network 104 may provide wired or wireless communications between nodes, such as the computing device 108 or the server.

In examples, the text processing engine 110 may detect an initial typing of a word (e.g., “House”) on a textual user interface of the computing device 108. In other examples, the text processing engine 110 may detect a selection of the word on the textual user interface of the computing device 108. The user 106 may wish to re-case one or more characters of the word (e.g., edit the case of the one or more characters of the word from uppercase to lowercase or vice-versa). In an example, the user 106 may wish to re-case the entire word. To do so, the user 106 may be enabled to place an insertion point on the computing device 108, backspace over each character of the word, and re-type the entire word to edit the case. However, this manual process is time-consuming.

An alternative route may include use of the text processing engine 110. The text processing engine 110 may also detect a case of a first character of the word as uppercase (e.g., “House”). In response, the text processing engine 110 may determine a first suggestion that includes remaining characters of the word being lowercase (e.g., “House”). The text processing engine 110 may provide first suggestion to an application 112 or a display, engine 114 to be displayed. The text processing engine 110 may also detect a case of a second character of the word as uppercase (e.g., “House”). In response, the text processing engine 110 may determine a second suggestion that includes all characters of the word being uppercase (e.g., “HOUSE”). The text processing engine 110 may provide the second suggestion to the application 112 or the display engine 114 to be displayed.

While the example system in FIG. 1 has been described with specific components including the computing device 108, the text processing engine 110, the application 112, the, display engine 114, and the data service 102, embodiments are not limited to these components or system configurations and can be implemented with other system configuration employing fewer or additional components.

FIG. 1B is a conceptual diagram illustrating an example computing environment for re-casing words in response to receiving suggestion data from an app store, according to embodiments.

A diagram 100B illustrates an app store 108 including applications 106. The app store 108 is a marketplace that includes software programs (e.g., the applications 106 and other software programs) that are available for procurement and download. A user 102 may access the applications 106 over a network 104 by various devices including, but not limited to, a desktop computer, a computing device 112, a smart phone, a tablet device, a wearable device, and so on. In some examples, the app store 108 may be a cloud based service.

In other examples, the user 102 may provide search criteria to a search engine executed on the computing device 112 to search for one of the applications 106. In some examples, the search engine may be an independent search engine. In other examples, the search engine may be a part of the app store 108.

In some examples, one of the applications 106 may be an autocorrection application or a text processing application, among other examples. The application may be activated automatically, activated through execution of a toolbar, or activation through text selection, among other options. The suggestions may be provided for words, names, or phrases that are common to the user 102 or the computing, device 112, which may permit the user 102 to enter a word without entering each letter of the word. Some of the applications 106 may fill in the word automatically. In other examples, some of the applications 106 may require additional input from the user 102. For example, when the word is being composed, the application (e.g., the ace correction application or the text processing application) may analyze a correction history during a previous time period that tracks metadata and other information associated with each character of the word (e.g., data related to the word after being changed by the autocorrection application). Based on the analysis of the correction history, the application may provide suggestions for the word. The application may provide the suggestions to be displayed on one of the applications 106 or a display engine 110.

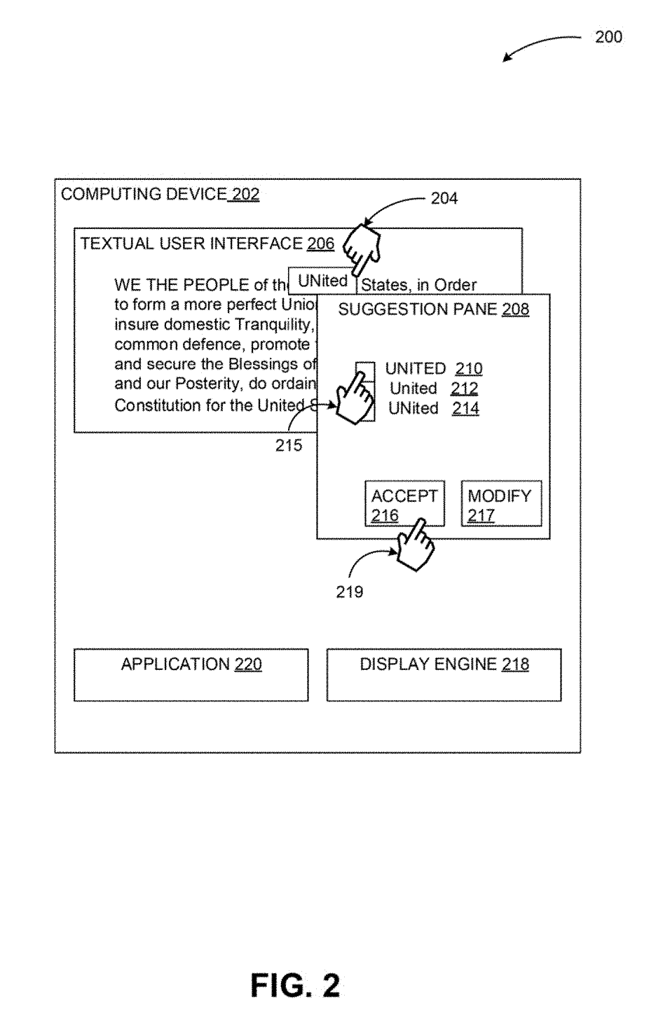

FIG. 2 is a display diagram illustrating a method to re-case words through providing suggestions in a suggestion pane on a textual user interface and prompting user action on the suggestion pane, according to embodiments.

As shown in a diagram 200, a computing device 202 may execute a text processing engine. The computing device 202 may include a display device, such as a touch enabled display component, and a monitor, among others, to provide the text processing engine to a user.

In some examples, the text processing engine may detect a user action 204 (e.g., a to touch-based input) executed on a textual user interface 200 of the computing device 202. Additional user actions may include gesture inputs, voice inputs, hover actions, voice commands, eye-tracking commands, and/or a gyroscopic input, among others. In some examples, the text processing engine may receive the user action 204 executed on the textual user interface 206, which may include the typing of a word (e.g., “UNited”) or a selection of the word (e.g., “UNited”) on the textual user interface 206, among other examples. The word may be selected by highlighting the word or hovering over the word on the textual user interface 206, for example.

The textprocessing engine may then detect a case of a first character (e.g., uppercase) of the word and a case of a second character (e.g., uppercase) of the word (e.g., “UNited”). The text processing engine may determine suggestions based on the case of the first character and the case of the second character of the word. The suggestions may include the first character of the word being capitalized (e.g., “United” 212), each character of the word being capitalized (e g., “UNITED” 210), and a variety of the characters of the word being capitalized (e.g., “UNited” 214), among other options.

In some examples, the text processing engine may detect the case of the first character (e.g., uppercase) as matching the case of the second character (e.g., uppercase) of the word (e.g., “UNited”). The text processing engine may identify the suggestion as including each character of the word being capitalized (e.g., “UNITED”), in additional examples, the text processing engine may detect the case of the first character (e.g., uppercase) as differing from the case of the second character (e.g., lowercase) of the word (e.g., “United”). The text processing engine may identify the suggestion as including the first character of the word being capitalized (e.g., “United”).

In some examples, the text processing engine may be integrated into a spellcheck system of the computing device 202. The text processing engine may present the suggestion s a suggestion pane 208 of the textual user interface 206. The suggestions may be based on a determined intent of the user. The user intent may be identified based on implementing one or more machine learning techniques to analyze a history associated with user actions executed on the textual user interface 206 during a previous time period.

The machine learning techniques may include pattern recognition and computational learning theory, among others. The machine learning techniques may include supervised learning algorithms, unsupervised learning algorithms, and reinfomement learning algorithms. Some of the machine learning algorithms may include linear regression algorithms, logistic regression algorithms, decision tree algorithms, support vector machine (SVM) algorithms, Naive Bayes algorithms, a K-nearest, neighbors (KNN) algorithm, a K-means algorithm, a random forest algorithm, dimensionality reduction algorithms, and a Gradient Boost & Adaboost algorithm, among others.

The supervised learning algorithms may use a dependent variable which is to be predicted from a given set of independent variables. Using the independent variables, a function may be generated that may map inputs to desired outputs. The training process may continue until the model achieves a desired level of accuracy on the training data. Examples of the supervised learning algorithms may include a regression learning algorithm, a decision tree learning algorithm, a random forest learning algorithm, a k-nearest neighbors algorithm, and a logistic regression algorithm, among others.

The unsupervised learning algorithms do not have outcome variables to predict/estimate, but the unsupervised learning algorithms may be used for clustering populations (e.g., the keywords) in different groups. Examples of the unsupervised learning algorithms may include an priori algorithm and a K-means algorithm, among others. An example reinforcement learning algorithm may include the Markov decision process algorithm.

The suggestions may vary in the case of one or more of the first character and the case of the second character of the word. Schemes may be used to distinguish the suggestions on the suggestion pane 208. The schemes may include a textual scheme, a graphical scheme, an audio scheme, an animation scheme, a coloring scheme, a highlighting scheme, and/or a shading scheme. Additionally, the schemes may be employed to distinguish attributes associated with the suggestions. The text processing engine may prompt the user to select one of the suggestions. The text processing engine may detect a selection action 215 of one of the suggestions. The word may be selected by highlighting the word or hovering over the word on the textual user interface 206, for example.

In other examples, the text processing engine may detect an additional user action 219 executed on the suggestion pane 208. The additional user action 219 may include an acceptance 216 of one of the suggestions, a modification 217 of the selected suggestion, or an addition of a new suggestion, etc. In other examples, the additional user action 219 may include an addition of feedback based on the suggestions. The feedback may include audio feedback, textual feedback, and/or graphical feedback, among other forms of feedback. The feedback may be used to re-validate and/or re-train the processes implemented by the machine learning techniques.

In other examples, the text processing engine may detect an input inactivity associated with the textual user interface 206 as exceeding an inactivity timing threshold (e.g., one minute, five minutes, one hour, two hours, etc.). The inactivity timing threshold may be system-dependent or may be customized by the user. In response, the text processing engine may auto-accept the suggestion used most frequently and may provide the suggestion to one of an application 220 or a display engine 218 to be displayed. The most-frequently used suggestion may be determined by implementing the one or more machine learning techniques to analyze the history associated with the user actions executed on the textual user interface 206 during the previous time period, as described previously.

In examples, based on the selection of the word (e.g., “UNited”) having the first and second character matching in case (e.g., uppercase) during a first time period, the text processing engine may provide the suggestions, “UNITED” 210, “United” 212, and “UNited” 214 in the suggestions pane 208 on the textual user interface 206. The text processing engine may utilize the one or more machine learning techniques to determine that the user selects the suggestion “UNITED” 210 most frequently during the previous time period. During a second time period, when another word. (e.g., “DOg”) is selected having the first and second character matching in case (e.g., uppercase), the text processing engine may auto-accept the suggestion having each character of the word capitalized (e.g., “DOG”) in response to a determination that the input inactivity associated with the textual user interface 206 exceeding the inactivity timing threshold. The suggestion of each character of the word being capitalized may be provided to one of the application 220 or the display engine 218 to be displayed, as well.

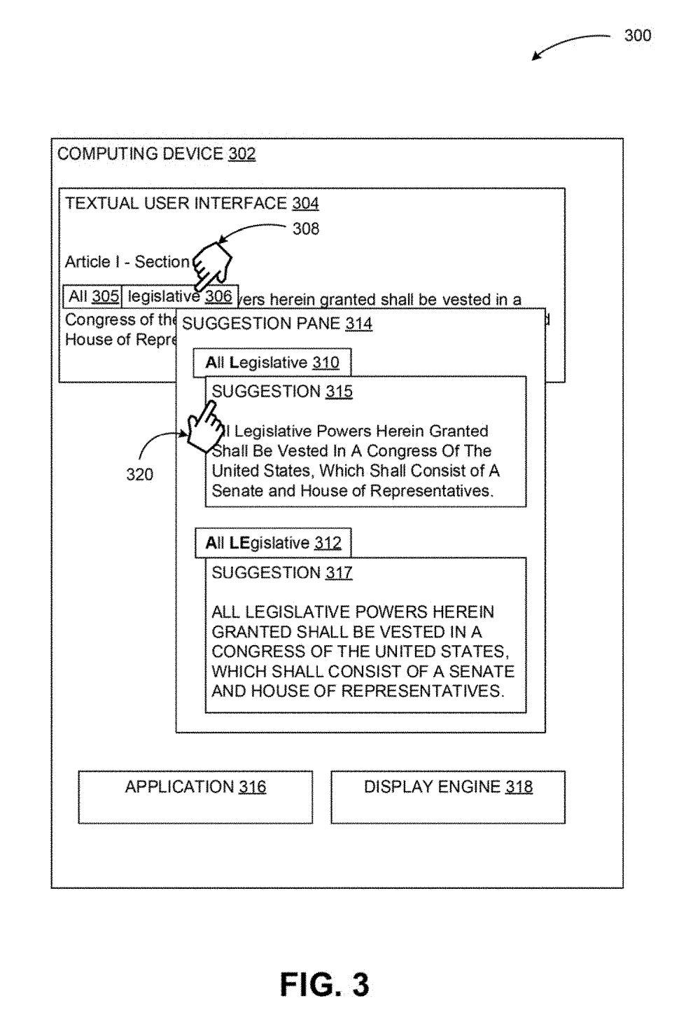

FIG. 3 is a display diagram illustrating a method to re-case words in a sentence based on inferred intent associated with user actions executed on the words, according to embodiments.

As shown in a diagram 300, a computing device 302 may execute a text processing engine. The computing device 302 may include a display device, such as a touch enabled display component, and a monitor, among others, to provide the text processing engine to a user.

In some examples, the text processing engine may detect a user action 308 (e.g., a touch-based input) executed on a textual user interface 304 of the computing device 302. The user action 308 may include a typing of a word (e.g., “legislative”) on the textual user interface 304 or a selection the word (e.g., “legislative”) on the textual user interface 304, among other actions. The word may be selected by highlighting the word or hovering over the word on the textual user interface 304, for example. The text processing engine may identify the word as being located in one of a document, a communication, or a web-based document. Examples of the communication may include an instant messaging communication, a textual communication, an email communication, a text message communication, an audio messaging communication, a video messaging communication, and/or a graphical messaging communication, among other forms of communication. The text processing engine may also detect the word (e.g., “legislative”) as being a part of a sentence (e.g., “All Legislative Powers herein granted shall be vested in a Congress of the United States, which shall consist of a Senate and House of Representatives”).

In some examples, the text processing engine may detect the case of the first character (e.g., uppercase) of a first word 305 (e.g., “All”) and may also detect the case of the first character (e.g., uppercase) of a second word 306 (e.g., “Legislative”) as matching (e.g., “All Legislative” 310). The text processing engine may then identify a suggestion 315 that may include the first character of each word in the sentence being capitalized. The suggestion 315 may be based on the first character of the first word 305 and the first character of the second word 306 being uppercase. For example, the suggestion 315 may include, “All Legislative Powers Herein Granted Shall Be Vested In A Congress Of The United States, Which Shall Consist Of A Senate And House Of Representatives.”

In other examples, the text processing engine may detect the case of the first character (e.g., uppercase) of the first word 305 (e.g., “All”), the case of the first character (e.g., uppercase) of the second word 306 (e.g., “LEgislative”), and the case of the second character (e.g., uppercase) of the second word 306 (e.g., “LEgislative”) as matching (e.g., “All LEgislative” 312). The text processing engine may identify a suggestion 317 (e.g., “ALL LEGISLATIVE POWERS HEREIN GRANTED SHALL BE VESTED IN A CONGRESS OF THE UNITED STATES, WHICH SHALL CONSIST OF A SENATE AND HOUSE OF REPRESENTATIVES”). The suggestion 317 may include each character in the sentence being capitalized and may be based on the case of the first character of the first word 305, the case of the first character of the second word 306, and the case of the second character of the second word 306 being uppercase.

In further examples, the text processing engine may detect the case of the first character (e.g., uppercase) of the first word 305 (e.g., “All”) and the case of the first character (e.g., uppercase) of the second word 306 (e.g., “Legislative”) as matching. The text processing engine may identify a case of a second character (e.g., lowercase) of the second word 306 (e.g., “Legislative”). The text processing engine may then identify the suggestion 315 (e.g., “All Legislative Powers Herein Granted Shall Be Vested In A Congress Of The United States, Which Shall Consist Of A Senate And House Of Representatives”). The suggestion 315 may include the first character of each word in the sentence being capitalized. The suggestion 315 may be based on the case of the first character of the first word 305 being uppercase, the case of the first character of the second word 306 being uppercase, and the case of the second character of the second word 306 being lowercase.

As described, the text processing engine may present the suggestion 315 and the suggestion 317 on a suggestion pane 314 of the textual user interface 304. Schemes may be used to distinguish the suggestion 315 and the suggestion 317 on the suggestion pane 314. The schemes may include a textual scheme, a graphical scheme, an audio scheme, an animation scheme, a coloring scheme, a highlighting scheme, and/or a shading scheme.

The text processing engine may prompt the user to select one of the suggestion 315 and the suggestion 317. The selected suggestion (e.g., the suggestion 315 or the suggestion 317) may be selected by highlighting the word or hovering over the word on the textual user interface 304, for example. The text processing engine may detect a selection action 320 executed on the suggestion pane 314 to select one of the suggestion 315 and the suggestion 317. In response, the text processing engine may provide the selected suggestion (e.g., one of the suggestion 315 or the, suggestion 317) to one of an application 316 or a display engine 318 to display.

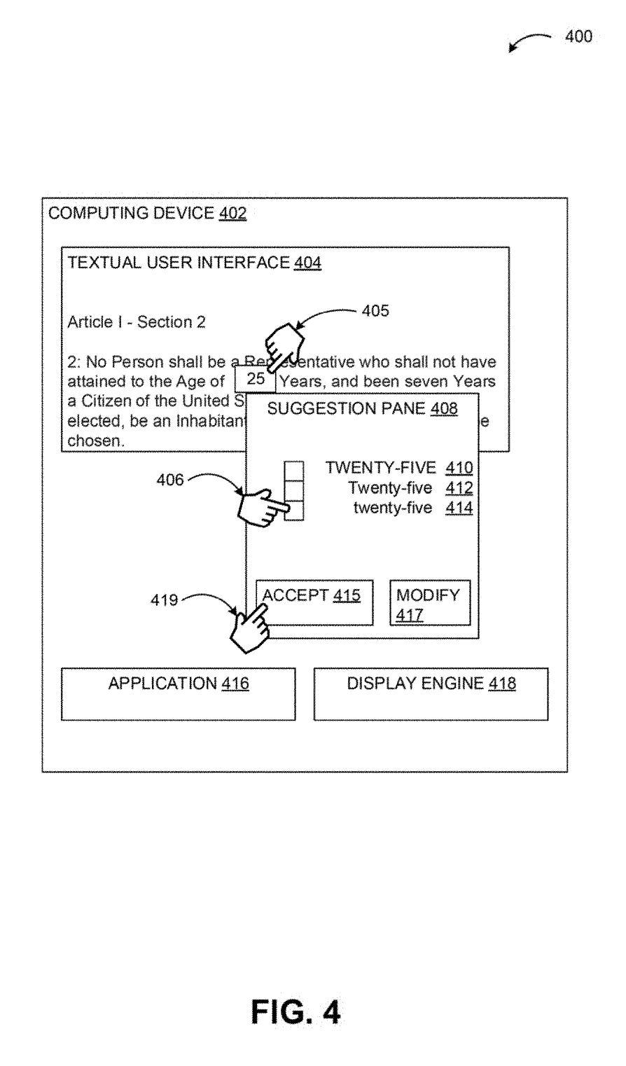

FIG. 4 is a display diagram illustrating a method to modify an Arabic numeral value with alphabetic characters associated with the Arabic numeral value through providing suggestions in a suggestion pane on a textual user interface and prompting user action on the suggestion pane, according to embodiments.

As shown in a diagram 400, a computing device 402 may execute a text processing engine. In some examples, the text processing engine may detect a user action 405 (e.g., a touch-based input) executed on a textual user interface 404 of the computing device 402. The user action 405 may include a typing of a word on the textual user interface 404, a selection of the word on the textual user interface 404, or a substitution action executed on the word to replace the Arabic numeral value with alphabetic characters associated with the Arabic numeral value, among other actions. The text processing engine may identify the word as being located in one of a document, a communication, or a we document. The text processing engine may also identify the word as including an Arabic numeral value (e.g, “25”).

In some examples, the text processing engine may present suggestions (e.g., “TWENTY-FIVE” 410, “Twenty-five” 412, and “twenty-five” 414) on a suggestion pane 408 408 on the textual user Interface 404. The text processing engine may prompt the user to select one of the suggestions. The text processing engine may detect a selection action 406 executed on the suggestion pane 408 to select one of the suggestions (e.g., “TWENTY-FIVE” 410, “Twenty-five” 412, and “twenty-five” 414).

In other examples, the text processing engine may detect an additional user action 419 executed on the suggestion pane 408. The additional user action 419 may include an acceptance 415 of one of the suggestions, a modification 417 of the selected suggestion, or an addition of a new suggestion, etc. The selected suggestion may be provided to one of the application 416 or the display engine 418 to be displayed.

In other examples, the text processing engine may detect an input inactivity associated with the textual user interface 404 as exceeding an inactivity timing threshold (e.g., one minute, five minutes, one hour, two hours, etc.). In response, the text processing engine may auto-accept the suggestion used most frequently and may provide the suggestion to one of the application 416 or the display engine 418 to be displayed. As described previously, the most-frequently used suggestion may be determined by implementing one or more machine learning techniques to analyze a history associated with user actions executed on the textual user interface 404 during a previous time period. The text processing engine may then provide, the suggestion to one of the application 416 or the display engine 418 to be displayed.

The example scenarios and schemas FIG. 1 through FIG. 4 are shown with specific components, data types, and configurations. Embodiments are not limited to systems according to these example configurations. Providing automatic case suggestion may be implemented in configurations employing fewer or additional components in applications and user interfaces. Furthermore, the example schema and components shown in FIG. 1 through FIG. 4 and their subcomponents may be implemented in a similar manner with other values using the principles described herein.

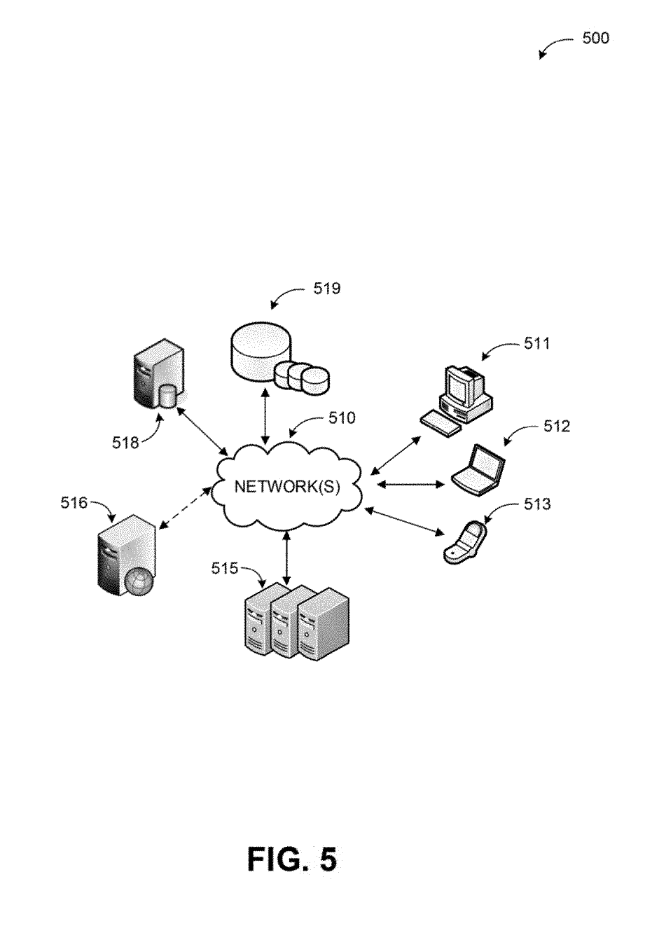

FIG. 5 is a simplified networked environment, where a system according to embodiments may be implemented.

As shown in a diagram 500, a data service may be implemented via software executed over servers 515. The platform may communicate with client applications (e.g., a text processing application) on individual computing devices such as a smart phone 513, a mobile computer 512, or desktop computer 511 (‘client devices’) through network(s) 510. The network(s) 510 may comprise any topology of servers, clients, Internet service providers, and communication media.

A system according to embodiments may have a static or dynamic topology. The network(s) 510 may include secure networks such as an enterprise network, an unsecured network such as a wireless open network, or the Internet. The network(s) 510 may also coordinate communication over other networks such as Public Switched Telephone Network (PSTN) or cellular networks. Furthermore, the network(s) 510 may include short range wireless networks such as Bluetooth or similar ones. The network(s) 510 provide communication between the nodes described herein. By way of example, and not limitation, the network(s) 510 may include wireless media such as acoustic, RF, infrared and other wireless media.

The servers 515 may include one or more data servers 516, where at least one of the one or more of the data servers 516 may be configured to execute one or more applications associated with the data service. In other examples, the data service may be provided by a third party service or may include a web application.

In some examples, the computing device may execute a text processing engine. The text processing engine may be configured to detect one of a typing or a selection of the word on a textual user interface of the computing device. The text processing engine may also detect a case of a first character and a case of a second character of the word. Then, the text processing engine may determine a suggestion that includes one of the first character of the word being capitalized or each character of the word being capitalized based on the case of the first character and the case of the second character of the word. The text processing engine may provide the suggestion to one of an application or a display engine to be displayed.

The data service may store suggestion data associated with the suggestions in a data store 519 directly or through a database server 518. Client applications executed on client devices 511-513 may be enabled to receive the suggestion data and render the textual user interface displaying information associated with displayed suggestions.

Client applications executed on any of the client devices 511-513 may facilitate communications via application(s) executed by the one or more data servers 516, or on an individual data server. A textual scheme, a graphical scheme, an audio scheme, an animation scheme, a coloring scheme, a highlighting scheme, and/or a shading scheme may be employed for providing automatic case suggestion.

Many other configurations of computing devices, applications, data sources, and data distribution systems may be employed for providing automatic case suggestion. Furthermore, the networked environments discussed in FIG. 5 are for illustration purposes only. Embodiments are not limited to the example applications, modules, or processes.

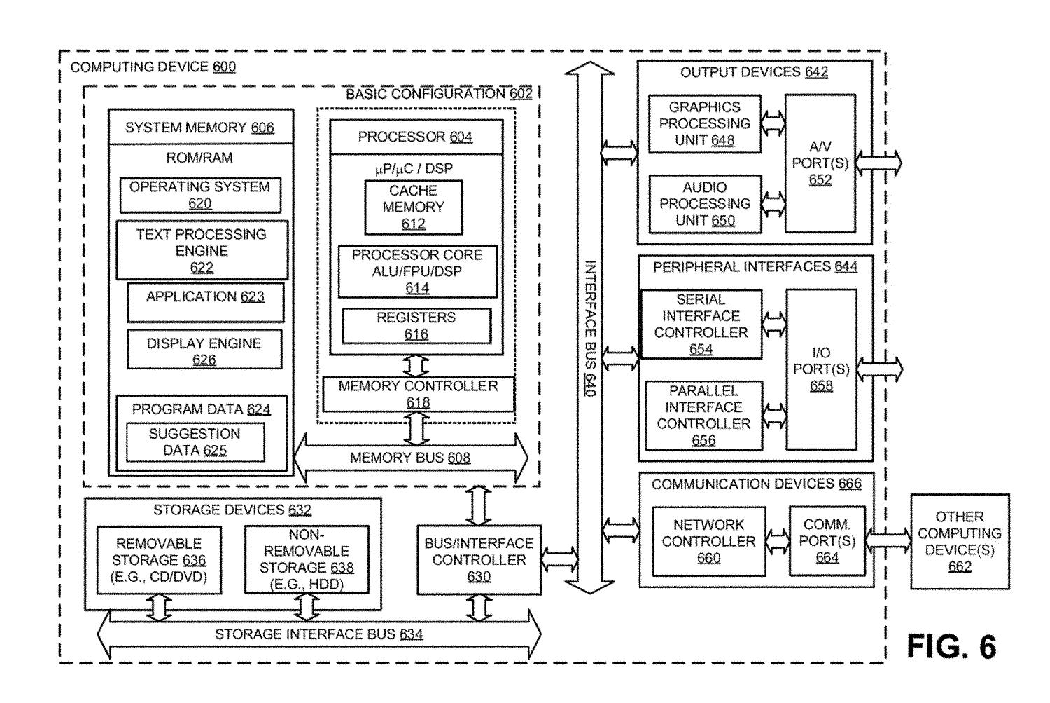

FIG. 6 is a block diagram of an example computing device, which may be used for providing automatic case suggestion, according to embodiments.

For example, a computing device 600 may be used as a server, desktop computer, portable computer, smart phone, special purpose computer, or similar device. In an example basic configuration 602, the computing device 600 may include one or more processors 604 and a system memory 606. A memory bus 608 maybe used for communication between the processor 604 and the system memory 606. The example basic configuration 602 may be illustrated in FIG. 5 by those components within the inner dashed line.

Depending on the desired configuration, the processor 704 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The one or more processor cores 614 may (each) include an arithmetic logic unit (ALU), a floating point unit (FPU), a digital signal processing core (DSP Core), or any combination thereof. An example memory controller 618 may also be used with the processor 604, or in some implementations, the example memory controller 618 may be an internal part of the processor 604.

Depending on the desired configuration, the system memory 606 may be of any type including but not limited to volatile memory (such as RAM), non-volatile memory (such as ROM, flash memory, etc.), of any combination thereof. The systemmemory 606 may include an operating system 620 a text processing engine 622, an application 623, a display engine 626, and a program data 624. The text processing engine 622 may be configured to detect a typing of a word on a textual user interface of the computing device or detect a selection of the word on the textual user interface. The text processing engine 622 may also be configured to detect a case of a first character and a case of a second character of the word. A suggestion may be determined based on the case of the first character and the case of the second character of the word. The suggestion may include one of the first character of the word being capitalize or each character of the word being capitalized. The text processing engine 622 may also provide the suggestion to one of the application 623 or the display engine 626 to be displayed. The program data 624 may include suggestion data 625 and other information, as described herein.

The computing device 600 may have additional features or functionality, and additional interfaces to facilitate communications between the example basic configuration 602 and any desired devices and interfaces. For example, a bus/interface controller 630 may be used to facilitate communications between the example basic configuration 602 and one or more data storage devices 632 via a storage interface bus 634. The data storage devices 632 may be one or more removable storage devices 636, one or more non-removable storage devices 638, or a combination thereof Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-rejmovable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the example basic configuration 602 via the bus/interface controller 630. Some of the one or more output devices 642 include a graphics processing unit 648 and an audio processing unit 650, which may be configured to communicate to various external devices such as a display or speakers via one or more A/V ports 652. The one or more peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc,) via one or more I/O ports 658. An example communication device 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods for providing automatic case suggestion. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

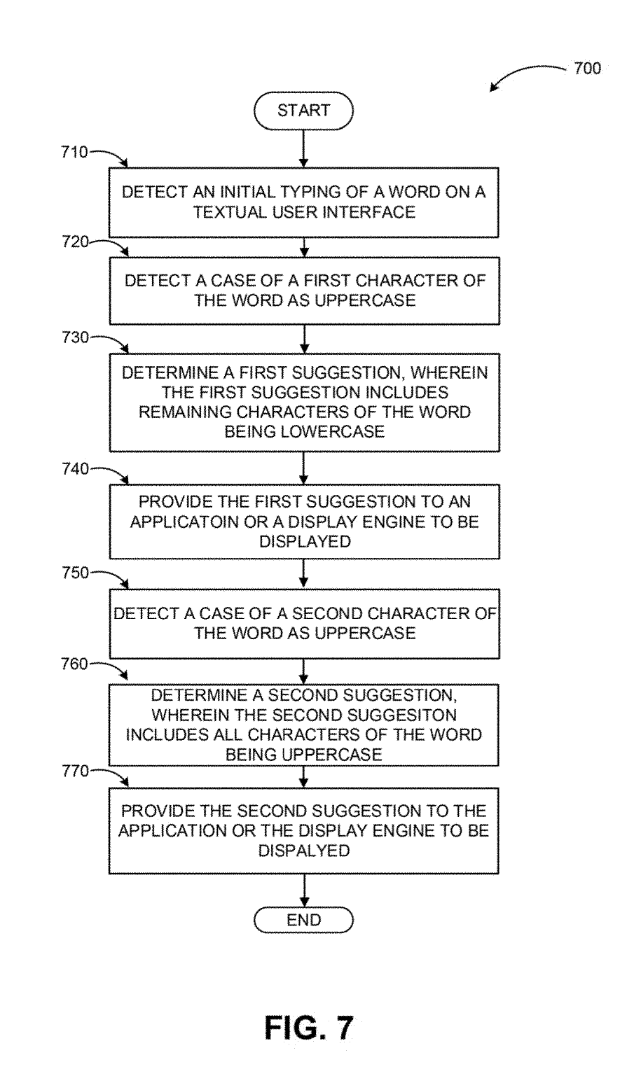

FIG. 7 is a logic flow diagram illustrating a process for providing automatic case suggestion, according to embodiments.

A process 700 may be implemented on a computing device, such as the computing device 600, or with another system. The computing device 600 may include a display device, such as a touch enabled display component, and a monitor, among others, to provide a text processing engine to a user.

The process 700 begins with operation 710, where the text processing engine may be configured to detect an initial typing of a word an a textual user interface. The word is located in one of a document, a communication, and a fillable form. In some examples, the text processing engine may identify the word as including an Arabic numeral value and may detect a initiation of a substitution action executed on the word to replace the Arabic numeral value with alphabetic characters corresponding to the Arabic numeral value. The substitution action may be executed on the textual user interface.

At operation 720, the text processing engine may be configured to detect a case of a first character of the word as uppercase. At operation 730, the text processing engine may be configured to determine a first suggestion. The first suggestion includes remaining characters of the word being lowercase. In some examples, the text processing engine stay detect an input inactivity associated with the textual user interface as exceeding an inactivity timing threshold and may auto-accept the first suggestion. At operation 740, the text processing engine may be configured to provide the first suggestion man application or a display engine to be displayed.

At operation 750, the text processing engine may be configured to detect a case of a second character of the word as uppercase. At operation 760, the text processing engine may be configured to determine a second suggestion. The second suggestion includes all characters of the word being uppercase. At operation 770, the text processing engine may provide the second suggestion to the application or the display engine to be displayed. The first suggestion and/or the second suggestion may be determined based on implementing an intelligent learning algorithm to analyze a history associated with user actions executed on the textual user interface during a previous time period. The text processing engine may be further configured to detect an input inactivity associated with the textual user interface as exceeding an inactivity timing threshold, in response to implementing the intelligent learning algorithm, the text processing engine may further identify the second suggestion as a most-frequently used suggestion, auto-accept the second suggestion, and provide the second suggestion to the application or the display engine to be displayed.

The operations included in process 700 are for illustration purposes. Providing automatic case suggestion may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some embodiments, a means for providing automatic case suggestion may be described, which may include a means for detecting an initial typing of a word on a textual user interface, a means for detecting a case of a first character of the word as uppercase, a means for determining a first suggestion, a means for providing the first suggestion to an application or a display engine to be displayed, a means for detecting a case of a second character of the word as uppercase, a means for determining a second suggestion, and a means for providing the second suggestion to the application or the display engine to be displayed. The first suggestion may include remaining characters of the word being lowercase and the second suggestion may include all characters of the word being uppercase.

According to other embodiments, computing devices for providing automatic case suggestion may be described. An example computing device may include a memory configured to store instructions and a processor coupled to the memory. The processor may be configured to execute a text processing engine. The text processing engine may be configured to detect an initial typing of a word on a textual user interface, detect a case of a first character of the word as uppercase, and determine a first suggestion. The first suggestion may include remaining characters of the word being lowercase. The first suggestion may be provided to an application or a display engine to be displayed. The text processing engine may also be configured to detect a case of a second character of the word as uppercase and determine a second suggestion. The second suggestion may include all characters of the word being uppercase. The second suggestion may be provided to the application or the display engine to be displayed.

According to some embodiments, the text processing engine may also be configured to detect a re-typing of a selected word on the textual user interface, detect the case of the first character of the word as being modified to uppercase, and provide the first suggestion to the application or the display engine to be displayed. The text processing engine may also be configured to detect the case of the second character of the word as being modified to uppercase and provide the second suggestion to the application or the display engine to be displayed. The text processing engine may also be configured to detect a re-typing of the selected word on the textual user interface, detect the case of the first character of the word as being modified to lowercase, and provide the first suggestion to the application or the display engine to be displayed.

According to additional embodiments, the text processing engine may also be configured to detect a user action executed on the textual user interface. The user action may include an acceptance and/or a modification of one or more of the first and the second suggestion. The user action may be executed on the textual user interface.

According to some embodiments, the text processing engine may also be configured to detect an input inactivity associated with the textual user interface as exceeding an inactivity timing threshold, auto-accept the first suggestion, and provide the first suggestion to the application or the display engine to be displayed.

According to other embodiments, one or more of the first suggestion and the second suggestion is determined based on implementing an intelligent learning algorithm to analyze a history associated with user actions executed on the textual user interface during a previous titre period. In some examples, the text processing engine may be further configured to detect an input inactivity associated with the textual user interface as exceeding an inactivity timing threshold. In response to implementing the intelligent learning algorithm, the text processing engine may also be configured to identify the second suggestion as a most-frequently used suggestion, auto-accept the second suggestion, and provide the second suggestion to the application or the display engine to be displayed.

According to some embodiments, the text processing engine may be further configured to prompt a selection of one of the first suggestion and the second suggestion through a suggestion pane of the textual user interface, detect a selection of one of the first suggestion and the second suggestion, and provide the selected one of the first suggestion and the second suggestion to the application or the display engine to be displayed. The text processing engine may be further configured to prompt a selection of one of the first suggestion and the second suggestion through a suggestion pane of the textual user interface, detect a rejection of the first suggestion and the second suggestion, and keep the word unchanged.

According to additional embodiments, the text processing engine may be further configured to identify the word as including an Arabic numeral value, detect an initiation of a substitution action executed on the word to replace the Arabic numeral value with alphabetic characters corresponding to the Arabic numeral value, and execute the substitution action on the textual user interface. The word may be located in one of a document, a communication, and a fillable form.

According to other examples, methods executed on computing devices for providing automatic case suggestion may be described. An example method may include detecting an initial typing of a word. The word is located in one of a document, a communication, and a fillable form. The example method may further include detecting a case of a first character of the word as uppercase and determining a first suggestion. The first suggestion includes remaining characters of the word being lowercase. The example method may additionally include providing the first suggestion to be displayed, detecting a case of a second character of the word as uppercase, and determining a second suggestion. The second suggestion includes all characters of the word being uppercase. The example method may further include providing the second suggestion to be displayed.

According to additional embodiments, the example method may further include detecting the word as being a part of a sentence, detecting a case of a first character of a first word and a case of a first character of a second word as matching, and determining a third suggestion. The case of the first character of the first word and the case of the first character of the second word are uppercase. The third suggestion includes a first character of each word in the sentence being uppercase.

According to other embodiments, the example method may further include detecting the word as being a part of a sentence, detecting a case of a first character of a first word, a case of a first character of a second word, and a case of a second character of the second word as matching, and determining a third suggestion. The case of the first character of the first word, the case of the first character of the second word, and the case of the second character of the second word are uppercase. The third suggestion includes each character of each word in the sentence being uppercase.

According to further embodiments, the example method may further include detecting the word as being a part of a sentence and detecting a case of a first character of a first word and a case of a first character of a second word as matching. The case of the first character of the first word and the case of the first character of the second word are uppercase. The example method may further include identifying a case of a second character of the second word as differing from the case of the first character of the second word, and determining a third suggestion. The second character of the second word is lowercase. The third suggestion includes a first character of each word in the sentence being uppercase.

According to some examples, computer-readable storage devices with instructions stored thereon for providing automatic case suggestion may be described. The instructions may include detecting an initial typing of a word, detecting a case of a first character of the word as uppercase, determining a first suggestion, and providing the first suggestion to be displayed. The instructions may further include detecting a case of a second character of the word as uppercase, determining a second suggestion, and providing the second suggestion to be displayed. The word may be located in one of a document, a communication, and a fillable form. The first suggestion includes remaining characters of the word being lowercase. The second suggestion includes all characters of the word being uppercase.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing, the claims and embodiments.

What is claimed is:

1. A computing device to provide automatic case suggestion, the computing device comprising:
a memory configured to store instructions; and
a processor coupled to the memory, the processor configured to execute a text processing engine, wherein the text processing engine is configured to:
detect an initial typing of a word on a textual user interface;
detect a case of a first character of the word as uppercase;
determine a first suggestion, wherein the first suggestion includes remaining characters of the word being lowercase;
provide the first suggestion to an application or a display engine to be displayed;
detect a case of a second character of the word as uppercase;
determine a second suggestion, wherein the second suggestion includes all characters of the word being uppercase; and
provide the second suggestion to the application or the display engine to be displayed.

2. The computing device of claim 1, wherein the text processing engine is further configured to:
detect a re-typing of a selected word on the textual user interface;
detect the case of the first character of the word as being modified to uppercase;
provide the first suggestion to the application or the display engine to be displayed;
detect the case of the second character of the word as being modified to uppercase; and
provide the second suggestion to the application or the display engine to be displayed.

3. The computing device of claim 2, wherein the text processing engine is further configured to:
detect a re-typing of the selected word on the textual user interface;
detect the case of the first character of the word as being modified to lowercase; and
provide the first suggestion to the application of the display engine to be displayed.

4. The computing device of claim 1, wherein the text processing engine is further configured to:
detect a user action executed on the textual user interface, wherein the user action includes an acceptance or a modification of one or more of the first and the second suggestion; and
execute the user action on the textual user interface.

5. The computing device of claim 1, wherein the text processing engine is further configured to:
detect an input inactivity associated with the textual user interface as exceeding an inactivity timing threshold;
auto-accept the first suggestion; and
provide the first suggestion to the application or the display engine to be displayed.

6. The computing device of claim 1, wherein one or more of the first suggestion and the second suggestion is determined based on implementing an intelligent learning algorithm to analyze a history associated with user actions executed on the textual user interface during a previous time period.

7. The computing device of claim 6, wherein the text processing engine is further configured to:
detect an input inactivity associated with the textual user interface as exceeding an inactivity timing threshold;
in response to implementing the intelligent learning algorithm, identify the second suggestion as a most-frequently used suggestion;
auto-accept the second suggestion; and
provide the second suggestion to the application or the display engine to be displayed.

8. The computing device of claim 1, wherein the text processing engine is further configured to:
prompt a selection of one of the first suggestion and the second suggestion through a suggestion pane of the textual user interface;
detect a selection of one of the first suggestion and the second suggestion; and
provide the selected one of the first suggestion and the second suggestion to the application or the display engine to be displayed.

9. The computing device of claim 1, wherein the text processing engine is further configured to:
prompt a selection of one of the first suggestion and the second suggestion through a suggestion pane of the textual user interface;
detect a rejection of the first suggestion and the second suggestion; and
keep the word unchanged.

10. The computing device of claim 1, wherein the text processing engine is further configured to:
identify the word as including an Arabic numeral value;
detect an initiation of a substitution action executed on the word to replace the Arabic numeral value with alphabetic characters corresponding to the Arabic numeral value; and
execute the substitution action on the textual user interface.

11. The computing device of claim 1, wherein the word is located in one of a document, a communication, and a fillable form.

12. A method executed on a touch-based computing device to provide automatic case suggestion, the method comprising:
detecting an initial typing of a word, wherein the word is located in one of a document, a communication, and a fillable form;
detecting a case of a first character of the word as uppercase;
determining a first suggestion, wherein the first suggestion includes remaining characters of the word being lowercase;
providing the first suggestion to be displayed;
detecting a case of a second character of the word as uppercase;
determining a second, suggestion, wherein the second suggestion includes all characters of the word being uppercase; and
providing the second suggestion to be displayed.

13. The method of claim 12, further comprising:
detecting the word as being a part of a sentence;
detecting a case of a first character of a first word and a case of a first character of a second word as matching, wherein the case of the first character of the first word and the case of the first character of the second word are uppercase; and
determining a third suggestion, wherein the third suggestion includes a first character of each word in the sentence being uppercase.

14. The method of claim 12, further comprising:
detecting the word as being a part of a sentence;
detecting a case of a first character of a first word, a case of a first character of a second word, and a case of a second character of the second word as matching, wherein the case of the first character of the first word, the case of the first character of the second word, and the case of the second character of the second word are uppercase; and
determining a third suggestion, wherein the third suggestion includes each character of each word in the sentence being uppercase.

15. The method of claim 12, further comprising:
detecting the word as being a part of a sentence; and
detecting a case of a first character of a first word and a case of a first character of a second word as matching, wherein the case of the first character of the first word and the case of the first character of the second word are uppercase.

16. The method of claim 15, further comprising:
identifying a case of a second character of the second word as differing from the case of the first character of the second word, wherein the second character of the second word is lowercase; and
determining a third suggestion, wherein the third suggestion includes a first character of each word in the sentence being uppercase.

17. A computer-readable memory device with instructions stored thereon to provide automatic case suggestion, the instructions comprising:
detecting an initial typing of a word, wherein the word is located in one of a document, a communication, and a fillable form;
detecting a case of a first character of the word as uppercase;
determining a first suggestion, wherein the first suggestion includes remaining characters of the word being lowercase;
providing the first suggestion to be displayed;
detecting a case of a second character of the word as uppercase;
determining a second suggestion, wherein the second suggestion includes all characters of the word being uppercase; and
providing the second suggestion to be displayed.

18. The computer-readable memory device of claim 17, wherein the instructions further comprise:
detecting the word as being a part of a sentence;
detecting a case of a first character of a first word and a case of a first character of a second word as matching, wherein the case of the first character of the first word and the case of the first character of the second word are uppercase;
identifying a case of a second character of the second word as differing from the case of the first character of the second word, wherein the second character of the second word is lowercase; and
determining a third suggestion, wherein the third suggestion includes a first character of each word in the sentence being uppercase.

19. The computer-readable memory device of claim 17, wherein the instructions further comprise:
identifying the word as including an Arabic numeral value;
detecting an initiation of a substitution action executed on the word to replace the Arabic numeral value with alphabetic characters corresponding to the Arabic numeral value; and
executing the substitution action.

20. The computer-readable memory device of claim 17, wherein the instructions further comprise:
detecting a re-typing of a selected word;
detecting the case of the first character of the word as being modified to uppercase;
providing the first suggestion to be displayed;
detecting the case of the second character of the word as being modified to uppercase; and
providing the second suggestion to be displayed.
